(19) United States
(12) Patent Application Publication
(10) Pub. No.: US 2026/0304066 A1
(43) Pub. Date: Oct. 1, 2026

(54) ZONE-BASED PROXIMITY

(71) Applicant: QUALCOMM Incorporated, San Diego, CA (US)

(72) Inventors: Archit YADAV, Cambridge (GB); Benjamin TARLOW, Cambridge (GB); Abhishek PRASAD, Barrington (GB)

(21) Appl. No.: 19/094,742

(22) Filed: Mar. 28, 2025

(51) Int. Cl. H04W 4/021; H04W 64/00

(52) U.S. Cl. CPC H04W 4/021; H04W 64/00

(57) ABSTRACT

An apparatus for determining a proximity of a user equipment (UE) relative to a point of interest (POI) may obtain a first indication of a first location of the UE relative to a second location of a point of interest (POI). The apparatus may determine a distance between the first location of the UE and the second location of the POI based on the obtained first indication. The apparatus may output a second indication of whether the UE and the POI are within a proximity of one another based on the determined distance between the first location of the UE and the second location of the POI satisfying an uncertainty zone condition and based on whether a dwell time of the UE associated with the uncertainty zone condition satisfies a dwell time condition.

### TECHNICAL FIELD

The present disclosure relates generally to communication systems, and more particularly, to a positioning system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may obtain a location of the UE and a location of a point of interest (POI). The apparatus may output an indication of whether the UE and the POI are within a proximity of one another based on (a) a distance between the obtained first location of the UE and the obtained second location of the UE satisfying an uncertainty zone condition and (b) a dwell time of the UE associated with the uncertainty zone satisfying a dwell time condition.

In some aspects, the techniques described herein relate to a method for positioning, including: obtaining a first indication of a first location of a user equipment (UE) relative to a second location of a point of interest (POI); determining a distance between the first location of the UE and the second location of the POI based on the obtained first indication; and outputting a second indication of whether the UE and the POI are within a proximity of one another based on the determined distance between the first location of the UE and the second location of the POI satisfying an uncertainty zone condition and based on whether a dwell time of the UE associated with the uncertainty zone condition satisfies a dwell time condition.

In some aspects, the techniques described herein relate to a method, where outputting the second indication of whether the UE and the POI are within the proximity of one another includes: activating a proximity trigger at the UE in response to the second indication indicating that the UE and the POI are in proximity of one another; or activating an out of proximity trigger at the UE in response to the second indication indicating that the UE and the POI are not in proximity of one another.

In some aspects, the techniques described herein relate to a method, where outputting the second indication of whether the UE and the POI are within the proximity of one another includes: outputting the second indication of whether the UE and the POI are within the proximity of one another further based on whether a previous proximity indication of the UE indicated that the UE and the POI were within the proximity of one another.

In some aspects, the techniques described herein relate to a method, further including: determining whether the determined distance between the first location of the UE and the second location of the POI satisfies the uncertainty zone condition before outputting the second indication of whether the UE and the POI are within the proximity of one another.

In some aspects, the techniques described herein relate to a method, where determining the distance between the first location of the UE and the second location of the POI based on the obtained first indication includes: determining at least one of a Euclidian distance or a Manhattan distance between the first location of the UE and the second location of the UE based on the obtained first indication, where determining whether the determined distance between the first location of the UE and the second location of the POI satisfies the uncertainty zone condition includes: determining whether the determined distance between the first location of the UE and the second location of the UE satisfies the uncertainty zone condition based on the determined Euclidian distance or the determined Manhattan distance.

In some aspects, the techniques described herein relate to a method, where determining whether the determined distance between the first location of the UE and the second location of the UE satisfies the uncertainty zone condition includes: assigning a current distance zone to the UE based on the determined distance between the first location of the UE and the second location of the UE; and determining that the determined distance between the first location of the UE and the second location of the UE satisfies the uncertainty zone condition in response to the assigned current distance zone satisfying the uncertainty zone condition.

In some aspects, the techniques described herein relate to a method, where assigning the current distance zone to the UE based on the determined distance between the first location of the UE and the second location of the UE includes: assigning a temporary distance zone to the UE based on the determined distance between the first location of the UE and the second location of the POI; and determining the current distance zone based on whether a difference between the temporary distance zone and a previous distance zone assigned to the UE satisfies a condition distance value.

In some aspects, the techniques described herein relate to a method, further including: selecting the condition distance value from a plurality of condition distance values based on whether the temporary distance zone is greater than the previous distance zone.

In some aspects, the techniques described herein relate to a method, further including: determining whether the dwell time of the UE associated with the uncertainty zone condition satisfies the dwell time condition before outputting the second indication of whether the UE and the POI are within the proximity of one another.

In some aspects, the techniques described herein relate to a method, further including: resetting the dwell time of the UE associated with the uncertainty zone condition in response to a determination that the dwell time of the UE associated with the uncertainty zone condition does not satisfy the dwell time condition; resetting the dwell time of the UE associated with the uncertainty zone condition based on a second distance between a third location of the UE and a fourth location of the POI satisfying a proximity zone condition or an out of proximity zone condition; or resetting the dwell time of the UE associated with the uncertainty zone condition based on the third location of the UE or the fourth location of the POI failing to satisfy a validity condition.

In some aspects, the techniques described herein relate to a method, further including: incrementing the dwell time of the UE associated with the uncertainty zone condition in response to a determination that the determined distance between the first location of the UE and the second location of the POI satisfies the uncertainty zone condition.

In some aspects, the techniques described herein relate to a method, where incrementing the dwell time of the UE associated with the uncertainty zone condition includes: incrementing the dwell time of the UE by a first amount in response to the determined distance between the first location of the UE and the second location of the POI satisfying a first set of zone conditions; or incrementing the dwell time of the UE by a second amount in response to the determined distance between the first location of the UE and the second location of the POI satisfying a second set of zone conditions, where the first amount and the second amount are different, where the first set of zone conditions and the second set of zone conditions are non-overlapping zone conditions.

In some aspects, the techniques described herein relate to a method, further including: obtaining a third indication of a third location of the UE relative to a fourth location of the POI; and outputting a fourth indication that the UE and the POI are not within the proximity of one another based on a detection of an obstacle on a line of sight (LOS) path between the third location of the UE and the fourth location of the POI based on the obtained third indication.

In some aspects, the techniques described herein relate to a method, further including: obtaining a third indication of a third location of the UE relative to a fourth location of the POI; determining a second distance between the third location of the UE and the fourth location of the POI based on the obtained third indication; and outputting a fourth indication of whether the UE and the POI are within the proximity of one another based on the determined second distance between the third location of the UE and the fourth location of the POI satisfying a proximity zone condition or an out of proximity zone condition, where the proximity zone condition and the out of proximity zone conditions are non-overlapping.

In some aspects, the techniques described herein relate to a method, further including: obtaining a third indication of a third location of the UE relative to a fourth location of the POI; and outputting a fourth indication of whether a second proximity of the UE and the POI are able to be determined based on whether the obtained third indication satisfies a validity condition.

In some aspects, the techniques described herein relate to a method, further including: obtaining a fifth indication of a fifth location of the UE relative to a sixth location of the POI after the obtainment of the third indication; and assigning a maximum distance zone to the UE based on a determination that the obtained third indication does not satisfy the validity condition.

In some aspects, the techniques described herein relate to a method, further including: receiving, via a transceiver, a set of positioning signals, where obtaining the first indication of the first location of the UE relative to the second location of the POI includes: determining at least one of the first location of the UE, the second location of the POI, or the first location of the UE relative to the second location of the POI based on the received set of positioning signals.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating an example of positioning based on reference signal measurements, in accordance with various aspects of the present disclosure.

FIG. 5 is a diagram illustrating an example of positioning based on reference signal measurements, in accordance with various aspects of the present disclosure.

FIG. 6 is a diagram illustrating an example of UE sensing based on measurements of positioning signals, in accordance with various aspects of the present disclosure.

FIG. 7 is a diagram illustrating an example of UE distance zones relative to a point of interest (POI), in accordance with various aspects of the present disclosure.

FIG. 8A and FIG. 8B are a diagrams illustrating an example of various methods of calculating a distance between a UE and a POI, in accordance with various aspects of the present disclosure.

FIG. 9 is a flowchart of a method of determining a zone of a UE relative to a POI, in accordance with various aspects of the present disclosure.

FIG. 10 is a flowchart of a method of updating a zone of a UE relative to a POI, in accordance with various aspects of the present disclosure.

FIG. 11 is a flowchart of a method of checking a LOS between a UE relative to a POI, in accordance with various aspects of the present disclosure.

FIG. 12 is a flowchart of a method of adjusting a dwell time of a UE's zone position relative to a POI, in accordance with various aspects of the present disclosure.

FIG. 13 is a communication flow diagram illustrating an example of a UE determining a zone of the UE relative to a POI, in accordance with various aspects of the present disclosure.

FIG. 14 is a flowchart of a method of zone proximity determination, in accordance with various aspects of the present disclosure.

FIG. 15 is a diagram illustrating an example of a hardware implementation for an example apparatus and/or network entity.

### DETAILED DESCRIPTION

In some aspects, the positive or negative proximity of a user equipment (UE) relative to a point of interest (POI) may be determined using a framework that uses one or more zones around the POI. A zone-based proximity component may dynamically configure the zones based on the UE position relative to the POI, for example by determining the location of the UE while assuming that the POI is in a static location. The zone-based proximity component may migrate the zone of the UE away from the POI (e.g., in a positive direction) or towards the POI (e.g., in a negative direction) based on the shortest distance between the UE and the POI, the zone that the UE is currently in, the direction of the movement of the UE relative to the POI, the dwell time of the UE within a set of zones, and/or an indication of whether there is a line of sight (LOS) between the UE and the POI.

Various aspects relate generally to positioning systems. Some aspects more specifically relate to zone-based positioning systems. In some examples, a UE may obtain an indication of a location of a UE relative to a location of a POI. For example, the UE may receive an indication of the location of the POI from a server and assume that the location of the POI is static. The UE may also perform positioning, for example via receiving a set of global position system (GPS) signals or by receiving positioning signals from a set of access points (AP) about the UE, to determine the location of the UE. In some aspects, a set of sensors may monitor the UE and a device that receives data from the set of sensors may transmit a report of the location of the UE via a wireless signal. In other aspects, the UE may perform positioning relative to the POI based on positioning signals (e.g., a positioning reference signal (PRS), a sensing signal) received at the UE to determine a distance between the UE and the POI. The UE may determine a distance between the location of the UE and the location of the POI based on the obtained indication of the location of the UE relative to the location of the POI. The UE may output an indication of whether the UE and the POI are within a proximity of one another based on the determined distance between the location of the UE and the location of the POI satisfying an uncertainty zone condition. The UE may output the indication of whether the UE and the POI are within a proximity of one another based on whether a dwell time of the UE associated with the uncertainty zone condition satisfies a dwell time condition. For example, the UE may designate a first set of zones closest to the POI to be proximity zones, where the UE indicates that the UE and the POI are within a proximity of one another if the UE is within the first set of zones. The UE may also designate a second set of zones furthest from the POI to be out-of-proximity zones, where the UE indicates that the UE and the POI are not within a proximity of one another if the UE is within the second set of zones. The UE may also designate a third set of zones between the first set of zones and the second set of zones, where the UE may indicate that the UE and the POI are, or are not, within a proximity of one another if the UE is within the third set of zones depending on whether the dwell time of the UE associated with the uncertainty zone satisfies a dwell time condition. For example, if the dwell time of the UE associated with the uncertainty zone condition is less than or equal to a dwell timer threshold value, the UE may indicate that the UE and the POI are within a proximity of one another, but if the dwell time of the UE associated with the uncertainty zone condition is greater than the dwell timer threshold value, the UE may indicate that the UE and the POI are not within a proximity of one another. The first set of zones, the second set of zones, and the third set of zones may be non-overlapping. An uncertainty zone condition may include a range of distances. The UE may determine that a distance satisfies the uncertainty zone condition if the distance falls within the range of distances. A dwell time condition may include a range of time periods. The UE may determine that a dwell time of the UE satisfies the dwell time condition of the dwell time falls within the range of time periods.

Particular aspects of the subject matter described in this disclosure may be implemented to realize one or more of the following potential advantages. In some examples, by including dwell time in the estimation of proximity, the UE may distinguish between a UE that passes by a POI and stops there, or a UE that simply passes by the POI, reducing the number of false positive detections. In some aspects, the UE may use a line of sight (LOS) between the UE and the POI to prohibit proximity detection, even at a small Euclidian distance. Such aspects may be useful in embodiments where the UE calculates its distance relative to the POI based on a round trip time (RTT) signal between the UE and the POI, where the distance between the UE and the POI may lose accuracy in situations where there is no LOS path between the UE and the POI. In some aspects, the UE may restrict the rate of increase to a further zone and/or restrict the rate of decrease to a closer zone, reducing the number of false alarms and ensuring that the performance of calculating movement of the UE between zones is smoother. Using a combination of the distance-based zones, dwell time, restricted movement between zones, and/or LOS prohibitions to decide on proximity may improve the stickiness of zone calculations where positioning signals may be lost or interfered with for a period of time.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with a set or a subset of the RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

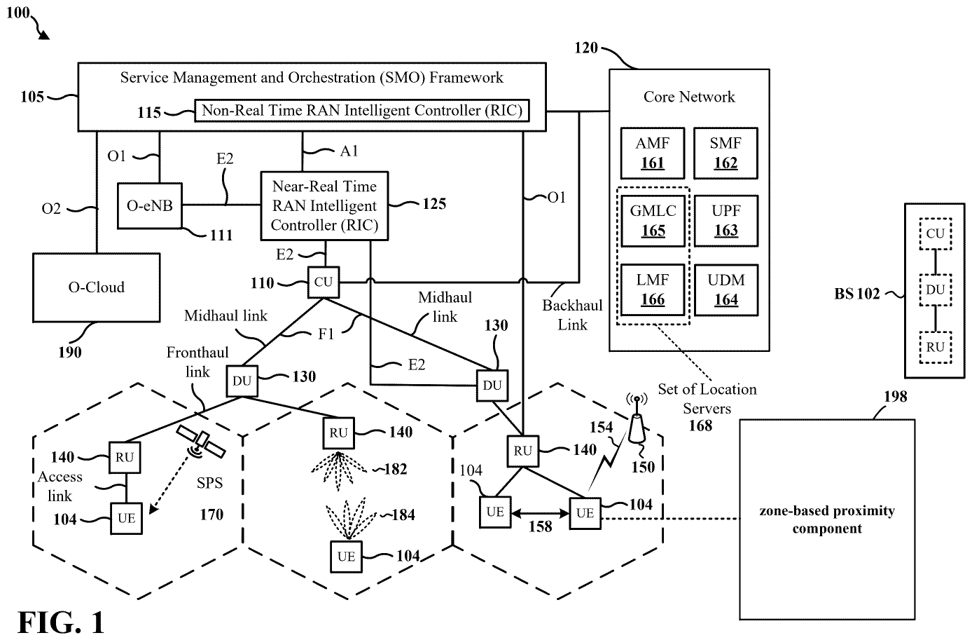

FIG. 1 is a diagram 100 illustrating an example of a wireless communications system and an access network. The illustrated wireless communications system includes a disaggregated base station architecture. The disaggregated base station architecture may include a set or a subset of the CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with a set or a subset of the DUs 130 via respective midhaul links, such as an F1 interface. The DUs 130 may communicate with a set or a subset of the RUs 140 via respective fronthaul links. The RUs 140 may communicate with UEs 104, respectively, via one or more radio frequency (RF) access links. In some implementations, the UE 104 may be simultaneously served by a plurality of the RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of a set or a subset of the RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by a set or a subset of the RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, a set of the RUs 140 can be implemented to handle over the air (OTA) communication with one or more UEs 104. In some implementations, real-time and non-real-time aspects of control and user plane communication with a set of the RUs 140 can be controlled by a corresponding set of the DUs 130. In some scenarios, this configuration can enable a set of the DUs 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with a set or a subset of the RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting a set or a subset of the CUs 110, a set or a subset of the DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

At least two of the UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a zone-based proximity component 198 that may be configured to obtain a location of the UE and a location of a POI. The zone-based proximity component 198 may be configured to output an indication of whether the UE and the POI are within a proximity of one another based on (a) a distance between the obtained location of the UE and the obtained location of the POI satisfying an uncertainty zone condition and (b) a dwell time of the UE associated with the uncertainty zone satisfying a dwell time condition.

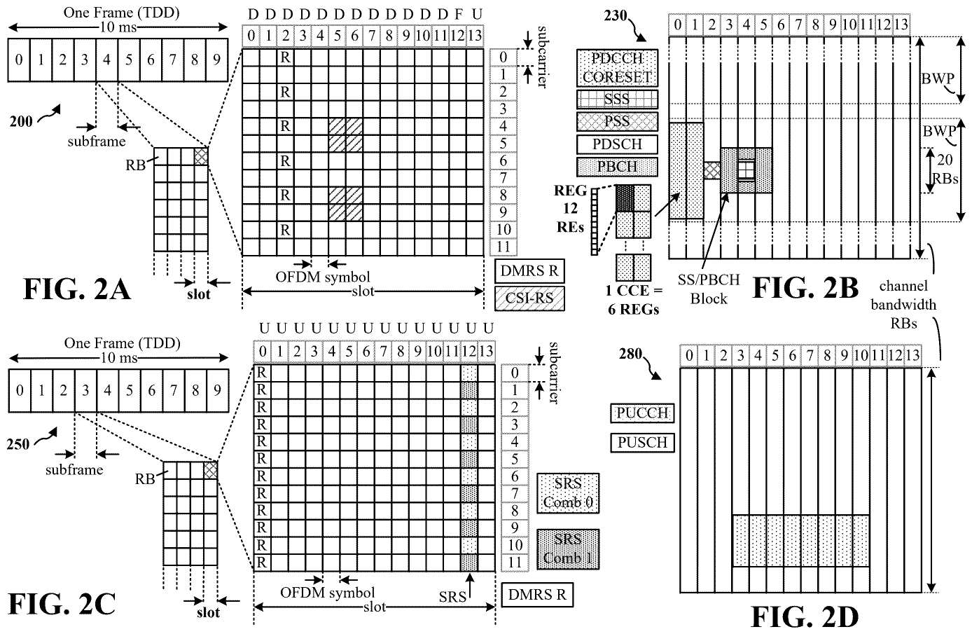

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

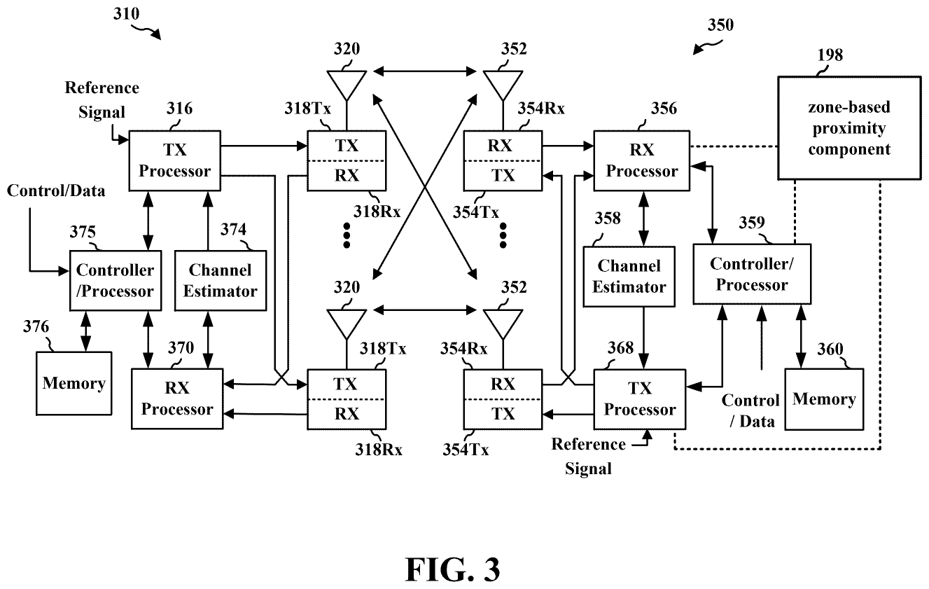

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to an RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the zone-based proximity component 198 of FIG. 1.

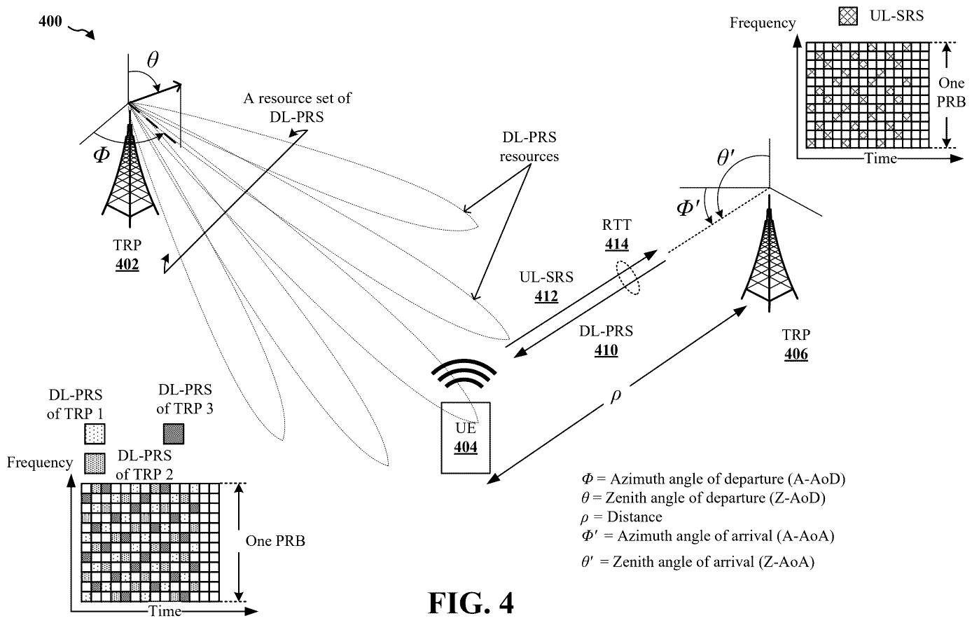

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

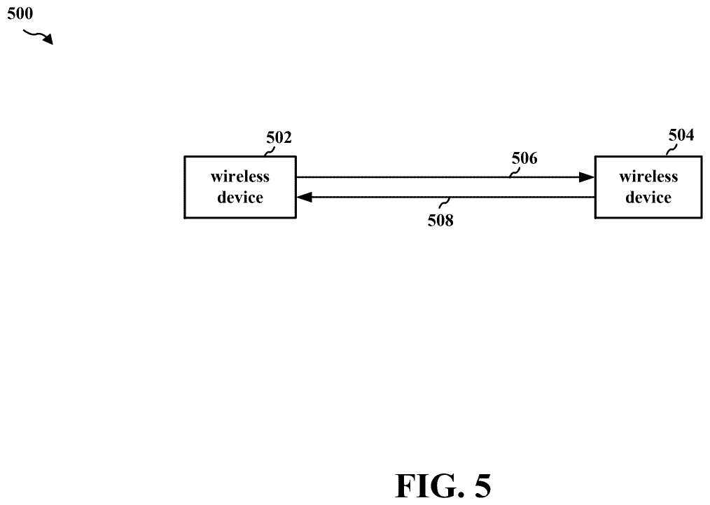

FIG. 5 is a diagram 500 illustrating an example of positioning based on reference signal measurements between any two wireless devices having transceivers. For example, the wireless device 502 may be a UE, a radio-frequency identification (RFID) tag, a backscattering-based communication device, or any other device that transmits wireless signals that may be transmitted and/or received by a transmitter. Similarly, the wireless device 504 may be a UE, an RFID tag, a backscattering-based communication device, or any other device that transmits wireless signals that may be transmitted and/or received by a transmitter.

For example, the wireless device 502 and the wireless device 504 may both be UEs that transmit signals directly to one another, for example PRS signals or sidelink signals. The wireless device 502 may transmit the signal 506 to the wireless device 504, which may, in response to receiving the signal 506, transmit the signal 508 to the wireless device 502. The wireless device 502 may then estimate a distance between the wireless device 502 and the wireless device 504 based on a round trip time (RTT) calculated between the transmission of the signal 506 and the reception of the signal 508.

In another example, the wireless device 502 may be a UE and the wireless device 504 may be a passive RFID tag that transmits the signal 508 in response to receiving the signal 506. A passive RFID tag may be an energy harvesting (EH) device configured to opportunistically harvest energy in the environment, such as solar energy, heat energy, and/or ambient RF energy. The passive RFID tag may store harvested energy using a power storage unit to power RF components, and may harvest energy from the signal 506 to empower a transmission of the signal 508. The wireless device 502 may estimate a distance between the wireless device 502 and the wireless device 504 based on an RTT calculated between the transmission of the signal 506 and the reception of the signal 508.

In another example, the wireless device 504 may have a transmitter that periodically transmits a signal beacon as the signal 508 to the wireless device 502. The wireless device 502 may then estimate a distance between the wireless device 502 and the wireless device 504 based on a received signal strength (e.g., a reference signal strength indicator (RSSI)) of the signal 508 as received by the wireless device 502.

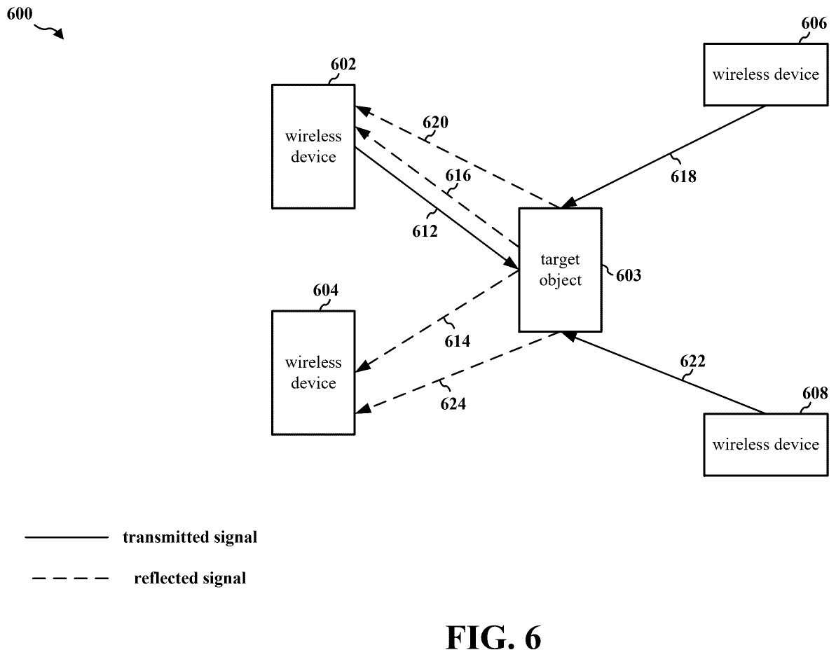

FIG. 6 is a diagram 600 illustrating an example of sensing based on measuring sensing signals transmitted by one or more sensing signals that reflect off of a target object 603. A wireless device that transmits a sensing signal that reflects off of a target object may be referred to as a transmitter node. A wireless device that receives a reflected sensing signal and measures the reflected sensing signal to perform sensing may be referred to as a receiver node. In one aspect, the wireless device 602 may perform monostatic sensing. The wireless device 602 may act as both a transmitter node and a receiver node. The wireless device 602 may transmit a set of sensing signals 612 at the target object 603, the target object 603 may reflect the set of sensing signals 612 as the reflected set of sensing signals 616 at the wireless device 602, and the wireless device 602 may measure the reflected set of sensing signals 616 from the target object 603. In another aspect, the wireless device 602 and the wireless device 604 may perform bistatic sensing. The wireless device 602 may act as a transmitter node and the wireless device 604 acts as a receiver node. The wireless device 602 may transmit a set of sensing signals 612 at the target object 603, the target object 603 may reflect the set of sensing signals 612 as the reflected set of sensing signals 614 at the wireless device 604, and the wireless device 604 may measure the reflected set of sensing signals 614 from the target object 603. In another aspect the wireless device 602 and the wireless device 606 may perform multi-static sensing. The wireless device 602 may act as both a transmitter node and a receiver node, for a first set of sensing signals, and the wireless device 606 acts as a transmitter node while the wireless device 602 acts as a receiver node for a second set of sensing signals. In addition to the wireless device 602 measuring the reflected set of sensing signals 616 from the target object 603 using monostatic sensing, the wireless device 606 may transmit a set of sensing signals 618 at the target object 603, the target object 603 may reflect the set of sensing signals 618 as the reflected set of sensing signals 620 at the wireless device 602, and the wireless device 602 may measure the reflected set of sensing signals 620 from the target object 603. In another aspect the wireless device 602, the wireless device 604, and the wireless device 608 may perform multi-static sensing. The wireless device 602 may act as a transmitter node and the wireless device 604 acts as a receiver node for a first set of sensing signals, and the wireless device 608 acts as a transmitter node and the wireless device 604 acts as a receiver node for a second set of sensing signals. In addition to the wireless device 604 measuring the reflected set of sensing signals 614 from the target object 603 using bistatic sensing, the wireless device 608 may transmit a set of sensing signals 622 at the target object 603, the target object 603 may reflect the set of sensing signals 622 as the reflected set of sensing signals 624 at the wireless device 604, and the wireless device 604 may measure the reflected set of sensing signals 624 from the target object 603. Each wireless device may be any wireless device configured to transmit or receive wireless signals, such as UEs, network nodes, TRPs, or base stations. For example, the wireless device 602 may be a network node configured to transmit the set of sensing signals 612 at the target object 603 and measure the reflected set of sensing signals 616 from the target object 603. In another example, the wireless device 602 may be a network node configured to transmit the set of sensing signals 612 at the target object 603, and the wireless device 604 may be a UE configured to measure the reflected set of sensing signals 614 from the target object 603.

The wireless device 602 may conduct one or more sensing measurements on the reflected set of sensing signals 616 and/or the reflected set of sensing signals 620. In one aspect, the wireless device 602 may calculate a distance or a range between the wireless device 602 and the target object 603 based on a round trip time (RTT) between when the wireless device 602 transmits the set of sensing signals 612 and when the wireless device 602 receives the reflected set of sensing signals 616. In one aspect, the wireless device 602 may calculate a distance or a range that the set of sensing signals 618 and the reflected set of sensing signals 620 travels based on a time between when the wireless device 606 transmits the set of sensing signals 618 and when the wireless device 602 receives the reflected set of sensing signals 620. In one aspect, the wireless device 602 may calculate a location of the target object 603 based on a plurality or range or distance measurements, for example via triangulation using known positions of the wireless devices 602 and 606 and the calculated range or distance measurements. In one aspect, the wireless device 602 may calculate a velocity of the target object 603 based on a first calculated location of the target object 603 based on the reflected set of sensing signals 616 and/or the reflected set of sensing signals 620 measured at a first time, and a second calculated location of the target object 603 based on the reflected set of sensing signals 616 and/or the reflected set of sensing signals 620 measured at a second time. In one aspect, the wireless device 602 may calculate an AoA of the reflected set of sensing signals 616 and/or an AoD of the set of sensing signals 612 based on a plurality of ports that transmitted the set of sensing signals 612 and a plurality of ports that received the reflected set of sensing signals 616. In one aspect, the wireless device 602 may calculate an AoA of the reflected set of sensing signals 620 and/or an AoD of the set of sensing signals 618 based on a plurality of ports that transmitted the set of sensing signals 618 and a plurality of ports that received the reflected set of sensing signals 620.

Similarly, the wireless device 604 may conduct one or more sensing measurements on the reflected set of sensing signals 614 and/or the reflected set of sensing signals 624. In one aspect, the wireless device 604 may calculate a distance or a range that the set of sensing signals 612 and the reflected set of sensing signals 614 travels based on a time between when the wireless device 602 transmits the set of sensing signals 612 and when the wireless device 604 receives the reflected set of sensing signals 614. In one aspect, the wireless device 604 may calculate a distance or a range that the set of sensing signals 622 and the reflected set of sensing signals 624 travels based on a time between when the wireless device 608 transmits the set of sensing signals 622 and when the wireless device 604 receives the reflected set of sensing signals 624. In one aspect, the wireless device 604 may calculate a location of the target object 603 based on a plurality or range or distance measurements, for example via triangulation using the known positions of wireless devices 602, 604, and 608, and the calculated range or distance measurements. In one aspect, the wireless device 604 may calculate a velocity of the target object 603 based on a first calculated location of the target object 603 based on the reflected set of sensing signals 614 and/or the reflected set of sensing signals 624 measured at a first time, and a second calculated location of the target object 603 based on the reflected set of sensing signals 614 and/or the reflected set of sensing signals 624 measured at a second time. In one aspect, the wireless device 604 may calculate an AoA of the reflected set of sensing signals 614 and/or an AoD of the set of sensing signals 612 based on a plurality of ports that transmitted the set of sensing signals 612 and a plurality of ports that received the reflected set of sensing signals 614. In one aspect, the wireless device 604 may calculate an AoA of the reflected set of sensing signals 624 and/or an AoD of the set of sensing signals 622 based on a plurality of ports that transmitted the set of sensing signals 622 and a plurality of ports that received the reflected set of sensing signals 624.

While a wireless device may sense parameters of the target object 603 by measuring a reflected set of sensing signals originating from a transmitter node, such a wireless device may improve its sensing by measuring two or more reflected sets of sensing signals originating from two or more transmitter nodes. For example, the wireless device 602 may improve its sensing by measuring the reflected set of sensing signals 616 originating from the wireless device 602 as the set of sensing signals 612 in addition to measuring the reflected set of sensing signals 620 originating from the wireless device 606 as the set of sensing signals 618. In another example, the wireless device 604 may improve its sensing by measuring the reflected set of sensing signals 614 originating from the wireless device 602 as the set of sensing signals 612 in addition to measuring the reflected set of sensing signals 624 originating from the wireless device 608 as the set of sensing signals 622.

While FIGS. 4-6 illustrate examples of positioning that may be used to determine a distance between a UE and a POI, other systems may be used to determine a distance between a UE and a POI, for example GPS devices located at each device which broadcast a location, or cameras that track a location of various devices within a room and broadcast the relative locations to a UE. Configuring a UE to determine whether it is within a proximity of a POI may be useful in a variety of aspects, for example within a supermarket or a retail space, a customer with a UE may obtain an alert from the UE when an object of interest (e.g., the POI) that the user wishes to purchase is within a proximity of the customer. In another example, a store associate with a UE may wish to know where a specific item (e.g., the POI) is located by obtaining an alert when the UE is within a proximity of the POI. In another example, a store manager tracking employees with UEs may want to verify that a location has been visited by an employee by tracking the dwell time of the employee in a particular location, which may indicate to the store manager that the employee has restocked that section of a warehouse. In another example, a UE may be configured to offer pricing to a user of the UE based on a proximity of the UE to a POI with an associated price, and may offer different discounts based on movement of the UE into and out of a zone of the POI. In another example, a UE may trigger an alert on a display of the UE associated with a product (e.g., a POI) in proximity of the UE that is on a shopping list associated with a user of the UE, or that is within a loyalty program associated with a user of the UE. In essence, a UE may be configured to transmit an alert to a user when in proximity of any POI within a variety of spaces, for example indoor spaces of airports, shopping malls, offices, or hospitals.

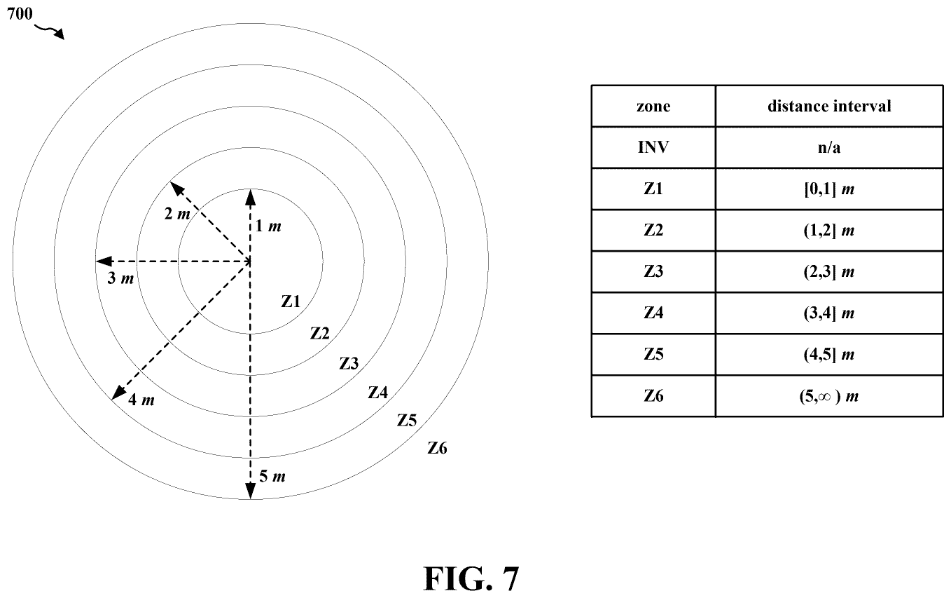

FIG. 7 is a diagram 700 illustrating an example of UE distance zones relative to a POI, in accordance with various aspects of the present disclosure. The center of the zone map on the left of diagram 700 may represent the location of the POI, and a UE may calculate its distance from the POI based on whether the UE falls within one of the zones indicated as Z1, Z2, Z3, Z4, Z5, and Z6. A zone may indicate a range of distance between the UE and the POI. For example, a UE that satisfies the zone condition of Z1 may have a distance greater than or equal to 0 m from the POI and less than or equal to 1 m from the POI, while a UE that satisfies the zone condition of Z2 may have a distance greater than 1 m from the POI and less than or equal to 2 m from the POI. A UE that satisfies the zone condition of Z6 may have a distance greater than 5 m from the POI.

In some aspects, a UE may be configured to have two zones, a first zone less than or equal to a threshold distance of the POI, and a second zone greater than the threshold distance of the POI. For example, a UE may estimate the position of the UE and calculate its distance from the POI to make use of a distance-based thresholding method to classify the object as in proximity to the user. In another example, the UE may measure the signal level of a transmitter at the POI, and trigger a proximity event at or above a prescribed threshold of signal strength. However, simply indicating that the UE is within a threshold distance of the POI or greater than the threshold distance of the POI may falsely trigger a proximity alert due to a spuriously high, one-off signal strength measurement (e.g., where reflective signals may aggregate), or may falsely not trigger a proximity alert due to a spuriously low, one-off signal strength measurement (e.g., where a direct LOS path between the UE and the POI is lost). While the aim of many proximity solutions may be to determine when a UE is within a proximity of a POI, determining the dwell time at the POI, or near the POI, may improve the accuracy of such proximity indications. By incorporating dwell time at the POI, the UE may enable the proximity to be detected reliably and promptly, so that an action may be taken in response to the proximity detection. Considering the dwell time may also not allow the proximity to be taken if the shortest path from the UE to the POI long (e.g., where there is no LOS path between the UE and the POI). Considering the dwell time may also avoid allowing the UE to trigger a false proximity alert during a spuriously high, one-off signal strength measurement. However, such approaches may be prone to edge-case errors, like a proximity estimate flicking in and out while the UE dwells at the border of a threshold. Moreover, such approaches fail to use information about spatial placement and/or movement of the UE and the POI with respect to the venue, and any obstacles between and/or around the UE and/or the POI. Moreover, such approaches are not flexible or resilient to the environment and type of receiver (e.g., gain, RSSI determination), as a single threshold may not be sufficient to determine how far/close the UE is with respect to the POI.

A UE may be configured to have a plurality of zones, such as the zones Z1, Z2, Z3, Z4, Z5, and Z6 shown in diagram 700, to determine movement of the UE between zones and calculate a newly computed zone based on the movement. For example, the newly computed zone may be referred to as zone_{new} while the previous computed zone may be referred to as zone_{old}. An invalid zone (e.g., where a location of either the UE or the POI may not be validly determined) may be referred to as an INV zone, whereas a valid calculated distance between the UE and the POI may be referred to as a distance within one of the zones Z1, Z2, Z3, Z4, Z5, and Z6. The UE may calculate the zone difference as zone_{new}−zone_{old}, such that a zone difference of 0 means that the UE stays within a zone, a positive difference value means that the UE moves away from the POI, and a negative difference value means that the UE moves towards the POI. In some aspects, the UE may use the information of the zone difference and direction to update the zone. In some aspects, the UE may restrict the movement of the UE towards or away relative to the POI. For example, the UE may not allow the UE to move away from the POI more than two zones per measurement period, and may not allow the UE to move towards the POI more than one zone per measurement period, or vice-versa.

A zone-based proximity component may divide the distance between the UE and the POI into a plurality of zones, where each non-overlapping zone is based on different distances between the UE and the POI. The zone-based proximity component may designate a subset of the zones as proximity zones. The zones may be specific to the POI and the UE, so if a zone-based proximity system has multiple POIs and multiple UEs, each UE-POI pair may have its own set of zone information (e.g., which zone a specific UE is in with respect to a specific POI). Based on the width of the zone, the UE may move from one zone to another as the distance between the POI and the UE changes. While the diagram 700 may indicate six zones, five of which having a width of 1 meter, any number of zones with any width may be designated by a zone-based proximity component.

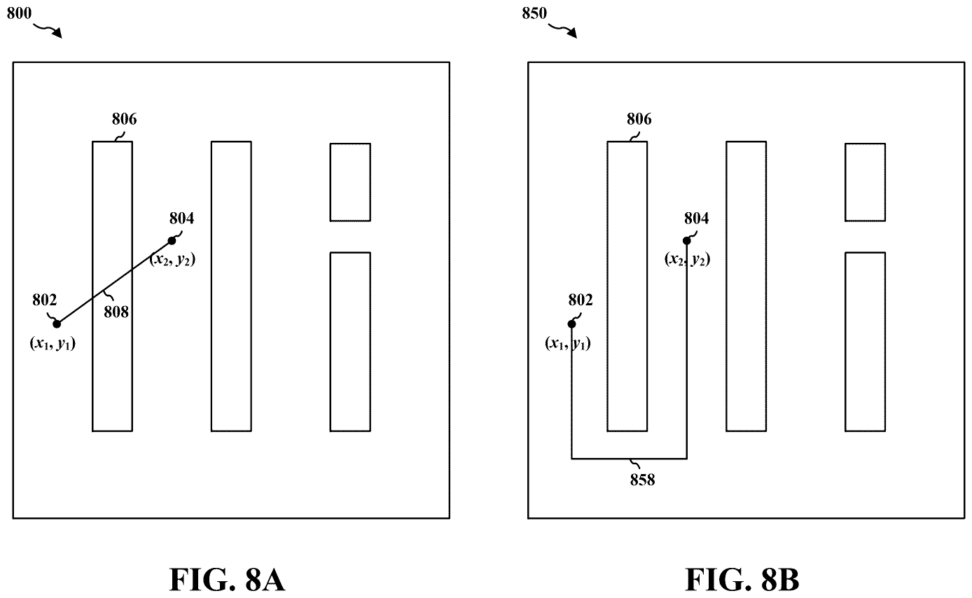

FIG. 8A is a diagram 800 illustrating an example of a method of calculating a distance between a UE 802 and a POI 804. The location of the UE 802 may be indicated by (x₁, y₁) while the location of the POI 804 may be indicated by (x₂, y₂). The distance 808 between the UE 802 and the POI 804 may be the shortest straight line between the two points indicated by (x₁, y₁) and (x₂, y₂), also referred to as the Euclidian distance. This assumes that the coordinates of both points, the position of the UE and the position of the POI, are known. In other aspects, a distance between the UE and the POI may be calculated based on positioning signals, for example a Wi-Fi based RTT calculation that estimates a distance between the UE and the POI based on a RTT of a Wi-Fi signal, or a Bluetooth™ based channel sounding calculation that estimates a distance between the UE and the POI based on the RTT of a Bluetooth™ signal. However, if an obstacle, such as the obstacle 806, exists in the path of the distance 808 between the UE 802 and the POI 804, an RTT measurement may be inaccurate. In some aspects, a UE may be configured to calculate the distance between the UE 802 and the POI 804 in another manner.

FIG. 8B is a diagram 850 illustrating another example of a method of calculating a distance between a UE 802 and a POI 804. The location of the UE 802 may again be indicated by (x₁, y₁) while the location of the POI 804 may again be indicated by (x₂, y₂). The distance 858 between the UE 802 and the POI 804 may be the shortest calculated path between the two points indicated by (x₁, y₁) and (x₂, y₂), also referred to as the Manhattan distance. A zone-based proximity component may calculate the Manhattan distance based on known paths that a UE may travel on, or may calculate the Manhattan distance based on known obstacles that the UE may not travel through. By calculating the distance based on the Manhattan distance, the UE may not use a LOS checker, as the Manhattan distance calculation may eliminate consideration of LOS paths between the UE and the POI.

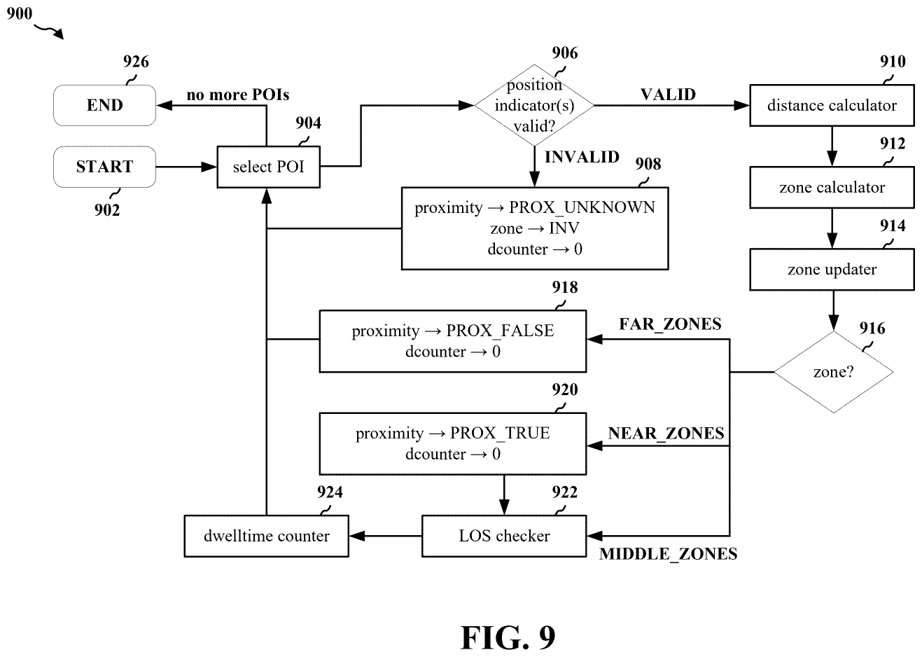

FIG. 9 is a flowchart 900 of a method of determining a zone of a UE relative to a POI, in accordance with various aspects of the present disclosure. At 902, a zone-based proximity component may start the process at 904, where the zone-based proximity component may select a POI. The zone-based proximity component may then proceed to determine whether the UE is within a proximity (e.g., PROX_TRUE) of the selected POI or out of a proximity (e.g., PROX_FALSE) from the selected POI.

At 906, the zone-based proximity component may determine whether a set of position indicators of the UE and/or the POI is valid. The set of position indicators may be used by the UE to determine a distance between the UE and the POI. For example, the UE may be determined to be outside the borders of a warehouse or a POI may be determined to be not within the shopping area of a store. In another example, the UE may be unable to calculate an RTT between the UE and the POI due to interference or noise from another wireless device. If the zone-based proximity component determines that the position of the UE and/or the position of the POI is invalid, at 908, the zone-based proximity component may set the proximity of the UE to be unknown (e.g., PROX_UNKNOWN) and the zone to be invalid (e.g., INV instead of one of the zones from Z1 to Z6). The zone-based proximity component may also reset a dwell time counter to zero, as the zone-based proximity component is unable to determine how long the UE is located in an unknown position.

If the zone-based proximity component determines that the position of the UE and the position of the POI are valid, at 910, the zone-based proximity component may determine a distance between the UE and the POI. The distance may be a Euclidian distance or a Manhattan distance. At 912, the zone-based proximity component may calculate the new zone (e.g., zone_{new}) based on the distance, and may feed both the new zone and the old zone (e.g., zone_{old}) to the zone updater at 914. At 914, the zone updater may determine how to increment or decrement the zone of the UE based on movement of the UE from one zone to another.

At 916, the zone-based proximity component may check the zone updated by the zone updater at 914. The zone-based proximity component may designate a first set of zones as FAR_ZONES, a second set of zones as PROX_ZONES, and a third set of zones as MIDDLE_ZONES. The PROX_ZONES may be referred to as a range of proximities to satisfy a proximity zone condition, the FAR_ZONES may be referred to as a range of proximities to satisfy an out of proximity zone condition, and the MIDDLE_ZONES may be referred to as a range of proximities to satisfy an uncertainty zone condition. The third set of zones may also be referred to as uncertainty zones. For example, with respect to the zones in FIG. 7, the zone-based proximity component may designate zones Z1 and Z2 as PROX_ZONES, zones Z3, Z4, and Z5 as MIDDLE_ZONES, and zone Z6 as the FAR_ZONES. In other words, the zone-based proximity component may determine that a UE within zones Z1 or Z2 of a POI may satisfy a proximity zone condition, determine that a UE within zones Z3, Z4, or Z5 may satisfy an uncertainty zone condition, and determine that a UE within zone Z6 may satisfy an out of proximity zone condition. If the zone-based proximity component determines that the zone updated by the zone updater at 914 satisfies the out of proximity zone condition (e.g., is one of the FAR_ZONES), at 918, the zone-based proximity component may set the proximity of the UE to an out of proximity zone state (e.g., PROX_FALSE), and may reset the dwell time counter (e.g., dcounter=0). If the zone-based proximity component determines that the zone updated by the zone updater at 914 satisfies the proximity zone condition (e.g., is one of the PROX_ZONES), at 920, the zone-based proximity component may set the proximity of the UE to a proximity zone state (e.g., PROX_TRUE), and reset the dwell time counter (e.g., dcounter=0). The zone-based proximity component may then proceed to check the LOS path at 922. If the zone-based proximity component determines that the zone updated by the zone updater at 914 satisfies the uncertainty zone condition (e.g., is one of the MIDDLE_ZONES), the zone-based proximity component may proceed to check the LOS path at 922.

If the distance calculator at 910 calculated a Euclidian distance between the UE and the POI, the LOS checker at 922 may invalidate any proximity zone determinations if there is not a direct LOS path between the UE and the POI. However, if the distance calculator at 910 calculated a Manhattan distance between the UE and the POI, the zone-based proximity component may bypass the LOS checker at 922 and proceed to determine whether the UE has dwelled within an uncertainty zone for a threshold period of time at 924. If the UE has dwelled within the uncertainty zone for a period of time that is greater than or equal to the dwell time threshold, the zone-based proximity component may determine that the UE is not within a proximity of the POI. However, if the UE has dwelled within one of the uncertainty zones within a threshold period of time and has previously been in a proximity zone state (e.g., PROX_TRUE), then the zone-based proximity component may determine that the UE is within a proximity of the POI. However, if the UE has dwelled within one of the uncertainty zones within a threshold period of time and has previously been in an out of proximity zone state (e.g., PROX_FALSE), then the zone-based proximity component may determine that the UE is out of the proximity of the POI.

At 904, the zone-based proximity component may select the same POI to perform the proximity check again with a new zone update, or may end the process at 926 when the zone-based proximity component receives an indication to stop calculating the UE's proximity relative to the POI.

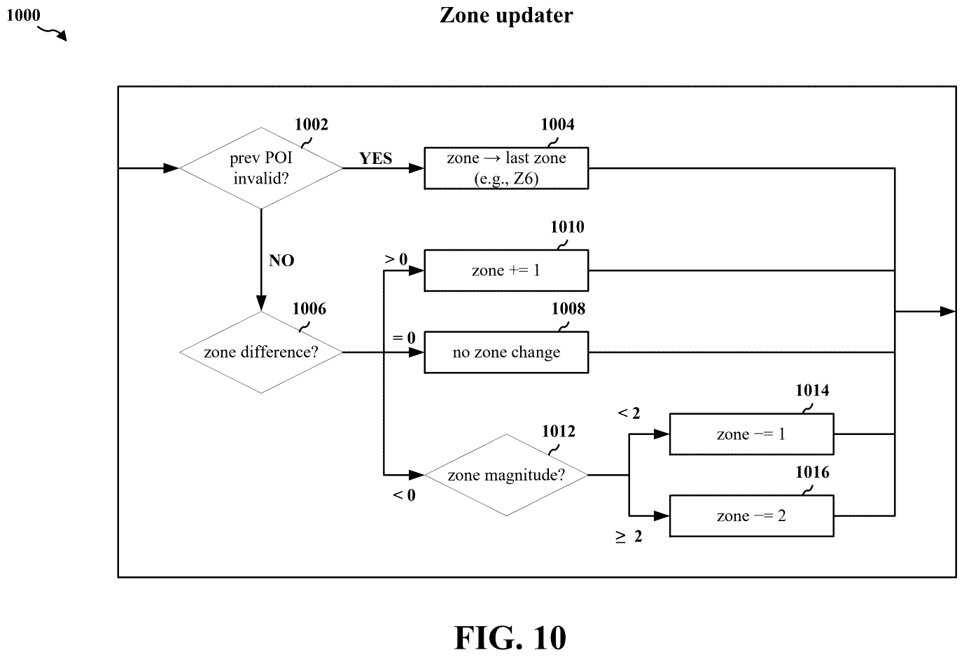

FIG. 10 is a flowchart 1000 of a method of updating a zone of a UE relative to a POI, in accordance with various aspects of the present disclosure. The flowchart 1000 illustrates the operation of a zone updater, such as the zone updater at 914 in FIG. 9. At 1002, the zone-based proximity component may determine whether the previous POI zone was invalid. In other words, the zone-based proximity component may determine if the zone_{old} was set to the value INV. If the zone-based proximity component determines that the previous POI zone was invalid, at 1004, the zone-based proximity component may set the zone of the UE to the outermost zone (e.g., zone Z6 in FIG. 7), as the zone-based proximity component is unable to increment or decrement a value from an unknown zone. The zone-based proximity component may be configured to set the zone of the UE to the outermost zone to prevent a spurious proximity reading from triggering a proximity alert if a position of a UE or a POI becomes is invalid. The system may then gradually move the zone of the UE down to the inner zones, ensuring that the system is more certain of the position after recovering from an invalid position estimate. If the zone-based proximity component determines that the previous POI zone was invalid, at 1006, the zone-based proximity component may determine a direction of the movement of the UE (e.g., zone_{new}-zone_{old}) to determine how much to increment or decrement the zone value associated with the UE.

If the zone-based proximity component determines that there is no movement (e.g., zone_{new}−zone_{old}=0), at 1008, the zone-based proximity component may not change the zone of the UE with respect to the POI. If the zone-based proximity component determines that there is a positive movement (e.g., zone_{new}−zone_{old}>0) away from the POI, at 1010, the zone-based proximity component may increment the zone by one. In other words, no matter how far the UE moves away from the POI, the zone-based proximity component may limit the movement of the UE away from the POI by one zone per proximity calculation period. If the zone-based proximity component determines that there is a negative movement (e.g., zone_{new}−zone_{old}<0) towards the POI, at 1012, the zone-based proximity component may determine the magnitude of the zone difference. If the magnitude is greater or equal to two, at 1016, the zone-based proximity component may decrement the zone by two zones. If the magnitude is less than two, at 1014, the zone-based proximity component may decrement the zone by one zone. In other words, the zone-based proximity component may limit the movement of the UE towards the POI by two zones per proximity calculation period. While the flowchart 1000 illustrates multiple zone decrement values for movement towards the POI and a single zone increment value for movement away from the POI, in other aspects, a zone-based proximity component may have multiple zone increment values for movement away from the POI and a single zone decrement value for movement towards the POI, or may have multiple zone increment values for movement away from the POI and multiple zone decrement values for movement towards the POI.

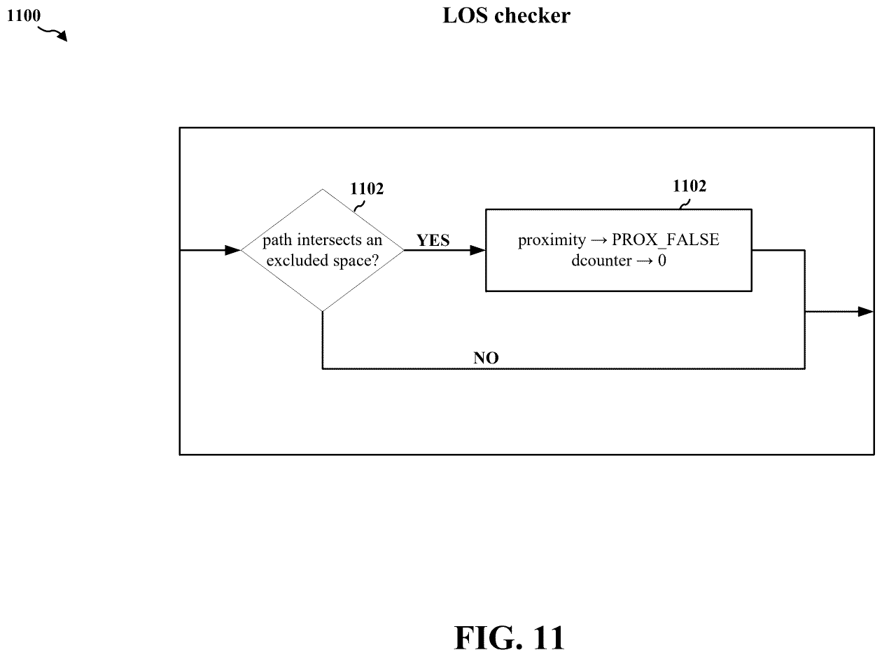

FIG. 11 is a flowchart 1100 of a method of checking a LOS between a UE relative to a POI, in accordance with various aspects of the present disclosure. The flowchart 1100 illustrates the operation of a LOS checker, such as the LOS checker at 922 in FIG. 9. At 1102, the zone-based proximity component may determine whether the path determined between the UE and the POI has an obstacle in between the UE and the POI, which may interfere with an accurate distance measurement. If the zone-based proximity component determines that there is a non-line of sight (NLOS) path between the UE and the POI, at 1102, the zone-based proximity component may set the zone of the UE relative to the POI to an out of proximity state (e.g., PROX_FALSE) and reset the dwell time counter (e.g., dcounter=0). If the zone-based proximity component determines that there is a LOS path between the UE and the POI, the zone-based proximity component may not change the proximity designation of the UE relative to the POI.

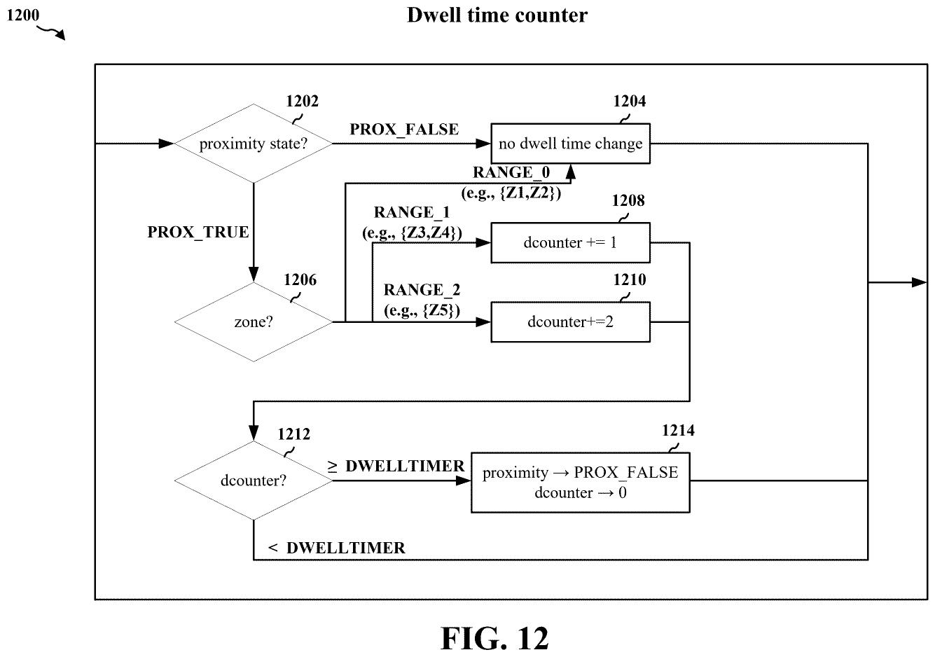

FIG. 12 is a flowchart 1200 of a method of adjusting a dwell time of a UE's zone position relative to a POI, in accordance with various aspects of the present disclosure. The flowchart 1200 illustrates the operation of a dwell time counter, such as the zone updater at 924 in FIG. 9. At 1202, the zone-based proximity component may determine the proximity state of the UE relative to the POI. If the proximity state of the UE is in an out of proximity state (e.g., set to PROX_FALSE), then, at 1204, the zone-based proximity component may not change the dwell time, as the dwell time counter was likely reset at the LOS checker. If the proximity state of the UE is in a proximity state (e.g., set to PROX_TRUE), then, at 1206, the zone-based proximity component may determine which of the zones the UE is in with respect to the POI. If the distance between the UE and the POI satisfies a proximity zone condition (e.g., is within one of the PROX_ZONES), then at 1204, the zone-based proximity component may not change the dwell time, as the dwell time counter was likely reset in response to the zone-based proximity component determining that the distance between the UE relative to the POI satisfies a proximity zone condition (e.g., is within one of the PROX_ZONES).

If the UE is within a first range of a set of uncertainty zones, referred to as RANGE_1 (e.g., zones Z3 or Z4), then at 1208, the zone-based proximity component may increment the dwell time counter by 1. However, if the UE is within a second range of the set of uncertainty zones, referred to as RANGE_2 (e.g., zone Z5), then at 1210, the zone-based proximity component may increment the dwell time counter by 2. In other words, the zone-based proximity component may increment the dwell time counter more if the UE is within an uncertainty zone that is further away from the POI than if the UE is within an uncertainty zone that is closer to the POI.

At 1212, the zone-based proximity component may determine whether the dwell time counter is greater or equal to a threshold dwell time counter. If the dwell time counter is greater or equal to the threshold dwell time counter, at 1214, the zone-based proximity component may set the proximity of the UE relative to the POI to an out of proximity state (e.g., PROX_FALSE) and may reset the dwell time counter. Otherwise, if the dwell time counter is less than the threshold dwell time counter, the zone-based proximity component may not alter the proximity of the UE relative to the POI, and may continue to monitor the dwell time of the UE within one of the uncertainty zones.

In other words, if the distance between the UE and the POI does not satisfy an out of proximity condition (e.g., within one of the FAR_ZONES, or is within zones Z1-Z5), but does not satisfy a proximity condition (e.g., within one of the PROX_ZONES), then the zone-based proximity component may set the proximity state of the UE relative to the POI to an out of proximity state (e.g., PROX_FALSE) based on the time spent not satisfying the proximity condition (e.g., outside of the PROX_ZONES), but satisfying the uncertainty zone condition (e.g., within one of the MIDDLE_ZONES). The counter to override the state of proximity to an out of proximity state may be based on the time the UE has spent within certain uncertainty zones, where an uncertainty zone further away from the POI results in a quicker transition to an out of proximity state while an uncertainty zone closer to the POI results in a slower transition to an out of proximity state. This may strike a balance between stickiness and change, where the zone-based stickiness may remain in place until the expiration of the dwell time timer.

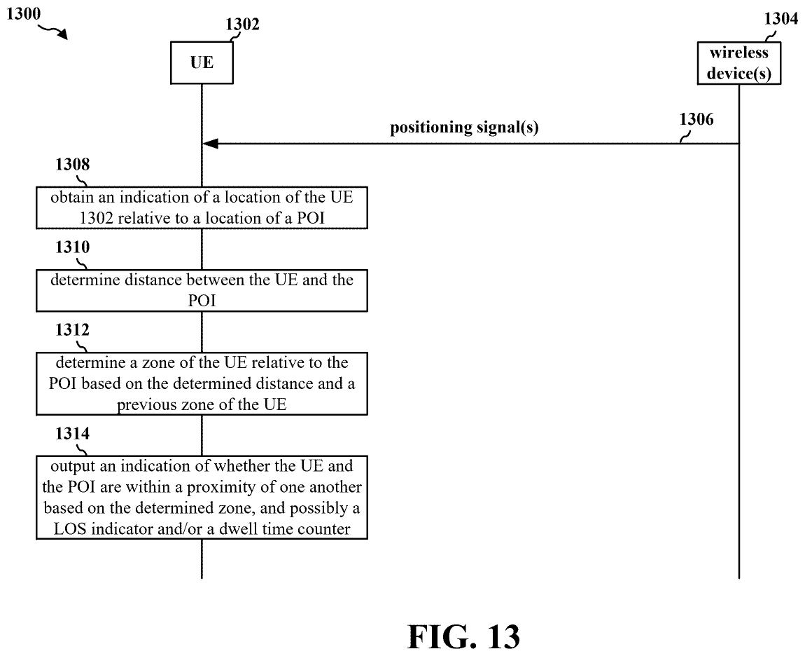

FIG. 13 is a communication flow diagram 1300 illustrating an example of a UE 1302 determining a zone of the UE 1302 relative to a POI, in accordance with various aspects of the present disclosure. A wireless device 1304 may output a set of positioning signals 1306 to the UE 1302. The wireless device 1304 may be, any device capable of transmitting positioning signals 1306 to the UE 1302, for example another UE, a POI having a transmitter, an AP monitoring the UE 1302 and/or the POI, or a POI made of a material that reflects sensing signals back to the UE 1302. The set of positioning signals 1306 may include, for example, GPS signals, indications of locations of the UE and/or the POI, PRS signals, sensing signals, and/or other wireless signals (e.g., Wi-Fi, Bluetooth) signals that may be used to determine a position of the UE 1302, a position of a POI, and/or a distance between the UE and the POI (e.g., using a calculated RTT).

At 1308, the UE 1302 may obtain an indication of a location of the UE 1302 relative to the location of the POI based on the received set of positioning signals 1306. For example, the UE 1302 may determine the location of the UE 1302 based on the set of positioning signals 1306. In another example, the UE 1302 may determine the location of the POI based on the set of positioning signals 1306. In another example, the UE 1302 the set of positioning signals 1306 may indicate the location of the UE 1302 and/or the location of the POI. In another example, the set of positioning signals 1306 may be used to calculate an RTT between the UE 1302 and the POI, which may be used to estimate a distance between the UE 1302 and the POI. At 1310, the UE 1302 may determine a distance between the location of the UE 1302 and the location of the POI based on the indication determined at 1308.

At 1312, the UE 1302 may determine a zone of the UE 1302 relative to the POI based on the determined distance and a previous zone of the UE. For example, if the UE 1302 is within the same zone as its previous zone, the UE 1302 may determine that the UE 1302 has not changed zones and may maintain the proximity state of the UE 1302. In another aspect, if the UE 1302 has moved to a zone closer to the POI, or to a zone further away from the POI, the UE 1302 may shift designated zone accordingly. While the UE 1302 shifts the designated zone, the UE 1302 may restrict the movement based on the direction of the zone movement (e.g., towards or away from the POI) and/or the magnitude of the zone difference (e.g., how many zones the UE 1302 has shifted).

At 1314, the UE 1302 may output an indication of whether the UE and the POI are within a proximity of one another based on the zone determined at 1314, and possibly a LOS indicator and/or a dwell time counter. For example, if the UE 1302 determines that the distance is within one of the PROX_ZONES or one of the FAR_ZONES, the UE 1302 may set the state of the UE 1302 relative to the POI to be within the proximity of the POI, or out of proximity of the POI, respectively. However, if the UE 1302 determines that the distance is within one of the MIDDLE_ZONES, the UE 1302 may determine whether the UE 1302 is within a proximity of the POI depending upon a dwell time counter and whether the UE was previously determined to be within a proximity of the UE. If the UE was previously determined to be within a proximity of the UE, but has moved to be within one of the MIDDLE_ZONES, the UE 1302 may maintain the state of the UE 1302 to be within a proximity of the POI, but may also increment a dwell time counter. The UE 1302 may increment the dwell time counter faster the further the UE 1302 is from the POI. The UE 1302 may increment the dwell time counter slower the closer the UE 1302 is from the POI. The UE 1302 may reset the dwell time counter if the UE 1302 moves into one of the PROX_ZONES. If the dwell time counter exceeds a dwell time threshold, the UE 1302 may set the state of the UE 1302 relative to the POI to be out of proximity of the POI. If the UE 1302 sets the state of the UE 1302 relative to the POI to be out of proximity of the POI, the UE 1302 may reset the dwell time counter. In some aspects, the UE 1302 may determine that the UE 1302 is not within a proximity of the POI if there is no LOS path between the UE 1302 and the POI-particularly if the UE determines the distance between the UE and the POI at 1310 to be a Euclidian distance instead of a Manhattan distance.

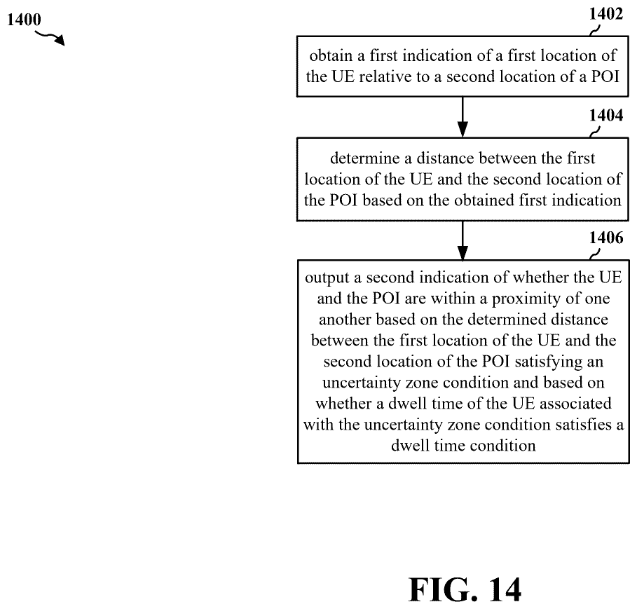

FIG. 14 is a flowchart 1400 of a method of determining a proximity of a UE and a POI. The method may be performed by a UE (e.g., the UE 104; the UE 1302; the apparatus 1504). At 1402, the UE may obtain a first indication of a first location of the UE relative to a second location of a POI. For example, 1402 may be performed by the UE 1302 in FIG. 13, which may, at 1308, obtain an indication of the location of the UE 1302 relative to the location of the POI. Moreover, 1402 may be performed by the component 198 in FIGS. 1, 3, and 15.

At 1404, the UE may determine a distance between the first location of the UE and the second location of the POI based on the obtained first indication. For example, 1404 may be performed by the UE 1302 in FIG. 13, which may, at 1310, determine a distance between the UE 1302 and the POI based on the indication obtained at 1308. Moreover, 1402 may be performed by the component 198 in FIGS. 1, 3, and 15.

At 1406, the UE may output a second indication of whether the UE and the POI are within a proximity of one another based on the determined distance between the first location of the UE and the second location of the POI satisfying an uncertainty zone condition and based on whether a dwell time of the UE associated with the uncertainty zone condition satisfies a dwell time condition. For example, 1406 may be performed by the UE 1302 in FIG. 13, which may output an indication of whether the UE and the POI are within a proximity of one another based on a distance between the obtained first location of the UE and the obtained second location of the POI satisfying an uncertainty zone condition and a dwell time of the UE associated with the uncertainty zone satisfying a dwell time condition. Moreover, 1404 may be performed by the component 198 in FIGS. 1, 3, and 15.

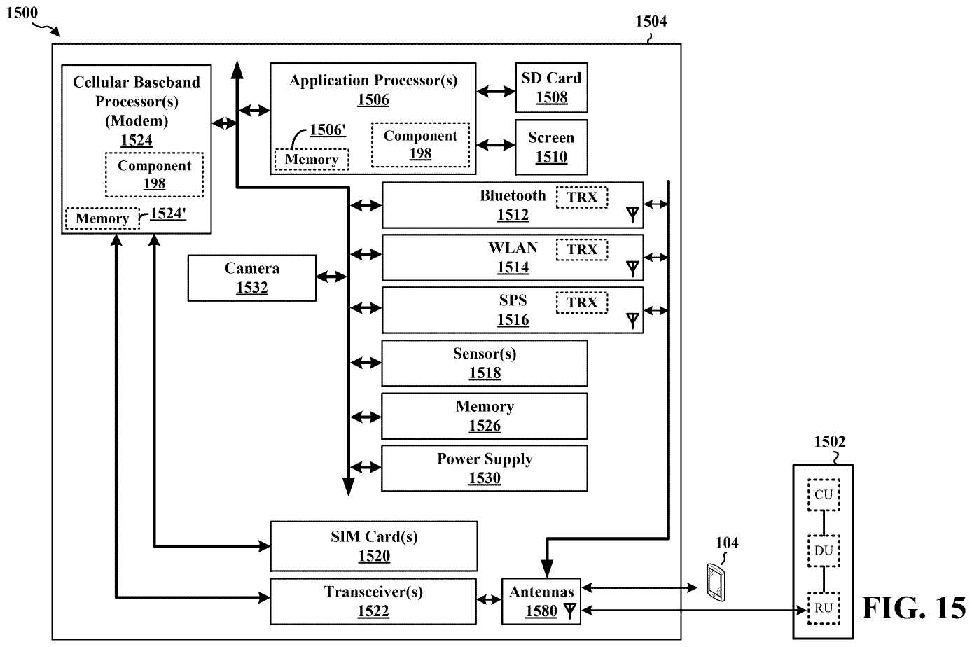

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), memory 1526 (which may include a plurality of memory modules), a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The memory 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 198 may be configured to obtain a location of the UE and a location of a POI. The component 198 may be configured to output an indication of whether the UE and the POI are within a proximity of one another based on (a) a distance between the obtained location of the UE and the obtained location of the POI satisfying an uncertainty zone condition and (b) a dwell time of the UE associated with the uncertainty zone satisfying a dwell time condition. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for obtaining a first indication of a first location of a UE (e.g., the apparatus 1504) relative to a second location of a POI. The apparatus 1504 may include means for determining a distance between the first location of the UE and the second location of the POI based on the obtained first indication. The apparatus 1504 may include means for outputting a second indication of whether the UE and the POI are within a proximity of one another based on the determined distance between the first location of the UE and the second location of the POI satisfying an uncertainty zone condition and based on whether a dwell time of the UE associated with the uncertainty zone condition satisfies a dwell time condition. The apparatus 1504 may include means for outputting the second indication of whether the UE and the POI are within the proximity of one another by (a) activating a proximity trigger at the UE in response to the second indication indicating that the UE and the POI are in proximity of one another, or (b) activating an out of proximity trigger at the UE in response to the second indication indicating that the UE and the POI are not in proximity of one another. The apparatus 1504 may be configured to activate the proximity trigger, and/or the out of proximity trigger, by outputting a notification to a display of the apparatus 1504. The apparatus 1504 may include means for outputting the second indication of whether the UE and the POI are within the proximity of one another by outputting the second indication of whether the UE and the POI are within the proximity of one another further based on whether a previous proximity indication of the UE indicated that the UE and the POI were within the proximity of one another. The apparatus 1504 may include means for determining whether the determined distance between the first location of the UE and the second location of the POI satisfies the uncertainty zone condition before outputting the second indication of whether the UE and the POI are within the proximity of one another. The apparatus 1504 may include means for determining the distance between the first location of the UE and the second location of the POI based on the obtained first indication by determining at least one of a Euclidian distance or a Manhattan distance between the first location of the UE and the second location of the UE based on the obtained first indication. The apparatus 1504 may include means for determining whether the determined distance between the first location of the UE and the second location of the POI satisfies the uncertainty zone condition by determining whether the determined distance between the first location of the UE and the second location of the UE satisfies the uncertainty zone condition based on the determined Euclidian distance or the determined Manhattan distance. The apparatus 1504 may include means for determining whether the determined distance between the first location of the UE and the second location of the UE satisfies the uncertainty zone condition by assigning a current distance zone to the UE based on the determined distance between the first location of the UE and the second location of the UE and determining that the determined distance between the first location of the UE and the second location of the UE satisfies the uncertainty zone condition in response to the assigned current distance zone satisfying the uncertainty zone condition. The apparatus 1504 may include means for assigning the current distance zone to the UE based on the determined distance between the first location of the UE and the second location of the UE by (a) assigning a temporary distance zone to the UE based on the determined distance between the first location of the UE and the second location of the POI, and (b) determining the current distance zone based on whether a difference between the temporary distance zone and a previous distance zone assigned to the UE satisfies a condition distance value. The apparatus 1504 may include means for selecting the condition distance value from a plurality of condition distance values based on whether the temporary distance zone is greater than the previous distance zone. The apparatus 1504 may include means for determining whether the dwell time of the UE associated with the uncertainty zone condition satisfies the dwell time condition before outputting the second indication of whether the UE and the POI are within the proximity of one another. The apparatus 1504 may include means for resetting the dwell time of the UE associated with the uncertainty zone condition in response to a determination that the dwell time of the UE associated with the uncertainty zone condition does not satisfy the dwell time condition. The apparatus 1504 may include means for resetting the dwell time of the UE associated with the uncertainty zone condition based on a second distance between a third location of the UE and a fourth location of the POI satisfying a proximity zone condition or an out of proximity zone condition. The apparatus 1504 may include means for resetting the dwell time of the UE associated with the uncertainty zone condition based on the third location of the UE or the fourth location of the POI failing to satisfy a validity condition. The apparatus 1504 may include means for incrementing the dwell time of the UE associated with the uncertainty zone condition in response to a determination that the determined distance between the first location of the UE and the second location of the POI satisfies the uncertainty zone condition. The apparatus 1504 may include means for incrementing the dwell time of the UE associated with the uncertainty zone condition by incrementing the dwell time of the UE by a first amount in response to the determined distance between the first location of the UE and the second location of the POI satisfying a first set of zone conditions. The apparatus 1504 may include means for incrementing the dwell time of the UE associated with the uncertainty zone condition by incrementing the dwell time of the UE by a second amount in response to the determined distance between the first location of the UE and the second location of the POI satisfying a second set of zone conditions. The first amount and the second amount may be different. The first set of zone conditions and the second set of zone conditions may be non-overlapping zone conditions. The apparatus 1504 may include means for obtaining a third indication of a third location of the UE relative to a fourth location of the POI. The apparatus 1504 may include means for outputting a fourth indication that the UE and the POI are not within the proximity of one another based on a detection of an obstacle on an LOS path between the third location of the UE and the fourth location of the POI based on the obtained third indication. The apparatus 1504 may include means for obtaining a third indication of a third location of the UE relative to a fourth location of the POI. The apparatus 1504 may include means for determining a second distance between the third location of the UE and the fourth location of the POI based on the obtained third indication. The apparatus 1504 may include means for outputting a fourth indication of whether the UE and the POI are within the proximity of one another based on the determined second distance between the third location of the UE and the fourth location of the POI satisfying a proximity zone condition or an out of proximity zone condition, where the proximity zone condition and the out of proximity zone conditions are non-overlapping. The apparatus 1504 may include means for obtaining a third indication of a third location of the UE relative to a fourth location of the POI. The apparatus 1504 may include means for outputting a fourth indication of whether a second proximity of the UE and the POI are able to be determined based on whether the obtained third indication satisfies a validity condition. The apparatus 1504 may include means for obtaining a fifth indication of a fifth location of the UE relative to a sixth location of the POI after the obtainment of the third indication. The apparatus 1504 may include means for assigning a maximum distance zone to the UE based on a determination that the obtained third indication does not satisfy the validity condition. The apparatus 1504 may include means for receiving, via a transceiver (e.g., the one or more antennas 1580), a set of positioning signals (PRSs, sensing signals). The apparatus 1504 may include means for obtaining the first indication of the first location of the UE relative to the second location of the POI by determining at least one of the first location of the UE, the second location of the POI, or the first location of the UE relative to the second location of the POI based on the received set of positioning signals.

The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, an “indication” of a set of data may include the set of data itself, or a reference to the set of data, where the reference may be used to retrieve the set of data. For example, an index may associate a set of data with an index value, and the indication of the set of data may include the index value, which may be used to determine the set of data by referring to the index.

The following aspects are illustrative only and may be combined with other aspects or teachings described herein, without limitation.

Aspect 1 is a method for positioning, comprising: obtaining a first indication of a first location of a user equipment (UE) relative to a second location of a point of interest (POI); determining a distance between the first location of the UE and the second location of the POI based on the obtained first indication; and outputting a second indication of whether the UE and the POI are within a proximity of one another based on the determined distance between the first location of the UE and the second location of the POI satisfying an uncertainty zone condition and based on whether a dwell time of the UE associated with the uncertainty zone condition satisfies a dwell time condition.

Aspect 2 is the method of aspect 1, wherein outputting the second indication of whether the UE and the POI are within the proximity of one another comprises: activating a proximity trigger at the UE in response to the second indication indicating that the UE and the POI are in proximity of one another; or activating an out of proximity trigger at the UE in response to the second indication indicating that the UE and the POI are not in proximity of one another.

Aspect 3 is the method of either of aspects 1 or 2, wherein outputting the second indication of whether the UE and the POI are within the proximity of one another comprises: outputting the second indication of whether the UE and the POI are within the proximity of one another further based on whether a previous proximity indication of the UE indicated that the UE and the POI were within the proximity of one another.

Aspect 4 is the method of any of aspects 1 to 3, further comprising: determining whether the determined distance between the first location of the UE and the second location of the POI satisfies the uncertainty zone condition before output of the second indication of whether the UE and the POI are within the proximity of one another.

Aspect 5 is the method of aspect 4, wherein determining the distance between the first location of the UE and the second location of the POI based on the obtained first indication comprises: determining at least one of a Euclidian distance or a Manhattan distance between the first location of the UE and the second location of the UE based on the obtained first indication, wherein determining whether the determined distance between the first location of the UE and the second location of the POI satisfies the uncertainty zone condition comprises: determining whether the determined distance between the first location of the UE and the second location of the UE satisfies the uncertainty zone condition based on the determined Euclidian distance or the determined Manhattan distance.

Aspect 6 is the method of either of aspects 4 or 5, wherein determining whether the determined distance between the first location of the UE and the second location of the UE satisfies the uncertainty zone condition comprises: assigning a current distance zone to the UE based on the determined distance between the first location of the UE and the second location of the UE; and determining that the determined distance between the first location of the UE and the second location of the UE satisfies the uncertainty zone condition in response to the assigned current distance zone satisfying the uncertainty zone condition.

Aspect 7 is the method of aspect 6, wherein assigning the current distance zone to the UE based on the determined distance between the first location of the UE and the second location of the UE comprises: assigning a temporary distance zone to the UE based on the determined distance between the first location of the UE and the second location of the POI; and determining the current distance zone based on whether a difference between the temporary distance zone and a previous distance zone assigned to the UE satisfies a condition distance value.

Aspect 8 is the method of aspect 7, further comprising: selecting the condition distance value from a plurality of condition distance values based on whether the temporary distance zone is greater than the previous distance zone.

Aspect 9 is the method of any of aspects 1 to 8, further comprising: determining whether the dwell time of the UE associated with the uncertainty zone condition satisfies the dwell time condition before output of the second indication of whether the UE and the POI are within the proximity of one another.

Aspect 10 is the method of aspect 9, further comprising: resetting the dwell time of the UE associated with the uncertainty zone condition in response to a determination that the dwell time of the UE associated with the uncertainty zone condition does not satisfy the dwell time condition; resetting the dwell time of the UE associated with the uncertainty zone condition based on a second distance between a third location of the UE and a fourth location of the POI satisfying a proximity zone condition or an out of proximity zone condition; or resetting the dwell time of the UE associated with the uncertainty zone condition based on the third location of the UE or the fourth location of the POI failing to satisfy a validity condition.

Aspect 11 is the method of any of aspects 1 to 10, further comprising: incrementing the dwell time of the UE associated with the uncertainty zone condition in response to a determination that the determined distance between the first location of the UE and the second location of the POI satisfies the uncertainty zone condition.

Aspect 12 is the method of aspect 11, wherein incrementing the dwell time of the UE associated with the uncertainty zone condition comprises: incrementing the dwell time of the UE by a first amount in response to the determined distance between the first location of the UE and the second location of the POI satisfying a first set of zone conditions; or incrementing the dwell time of the UE by a second amount in response to the determined distance between the first location of the UE and the second location of the POI satisfying a second set of zone conditions, wherein the first amount and the second amount are different, wherein the first set of zone conditions and the second set of zone conditions are non-overlapping.

Aspect 13 is the method of any of aspects 1 to 12, further comprising: obtaining a third indication of a third location of the UE relative to a fourth location of the POI; and outputting a fourth indication that the UE and the POI are not within the proximity of one another based on a detection of an obstacle on a line of sight (LOS) path between the third location of the UE and the fourth location of the POI based on the obtained third indication.

Aspect 14 is the method of any of aspects 1 to 13, further comprising: obtaining a third indication of a third location of the UE relative to a fourth location of the POI; determining a second distance between the third location of the UE and the fourth location of the POI based on the obtained third indication; and outputting a fourth indication of whether the UE and the POI are within the proximity of one another based on the determined second distance between the third location of the UE and the fourth location of the POI satisfying a proximity zone condition or an out of proximity zone condition, wherein the proximity zone condition and the out of proximity zone conditions are non-overlapping.

Aspect 15 is the method of any of aspects 1 to 14, further comprising: obtaining a third indication of a third location of the UE relative to a fourth location of the POI; and outputting a fourth indication of whether a second proximity of the UE and the POI are able to be determined based on whether the obtained third indication satisfies a validity condition.

Aspect 16 is the method of aspect 15, further comprising: obtaining a fifth indication of a fifth location of the UE relative to a sixth location of the POI after the obtainment of the third indication; and assigning a maximum distance zone to the UE based on a determination that the obtained third indication does not satisfy the validity condition.

Aspect 17 is the method of any of aspects 1 to 16, further comprising: receiving, via a transceiver, a set of positioning signals, wherein obtaining the first indication of the first location of the UE relative to the second location of the POI comprises: determining at least one of the first location of the UE, the second location of the POI, or the first location of the UE relative to the second location of the POI based on the received set of positioning signals.

Aspect 18 is the method of any of aspects 1 to 17, wherein outputting the indication of whether the UE and the POI are within the proximity of one another comprises: transmitting the indication of whether the UE and the POI are within the proximity of one another; or storing the indication of whether the UE and the POI are within the proximity of one another

Aspect 19 is an apparatus for wireless communication at a user equipment (UE), comprising: at least one memory; and at least one processor coupled to the at least one memory, the at least one processor is configured to perform the method of any of aspects 1 to 18.

Aspect 20 is an apparatus for wireless communication at a UE, comprising means for performing each step in the method of any of aspects 1 to 18.

Aspect 21 is the apparatus of any of aspects 1 to 17, further comprising a transceiver configured to receive or to transmit in association with the method of any of aspects 1 to 18.

Aspect 22 is a computer-readable medium (e.g., a non-transitory computer-readable medium) storing computer executable code at a UE, the code when executed by at least one processor causes the at least one processor to perform the method of any of aspects 1 to 18.

What is claimed is:

1. An apparatus for positioning at a user equipment (UE), comprising:
at least one memory; and
at least one processor coupled to the at least one memory and, based at least in part on information stored in the at least one memory, the at least one processor is configured to:
obtain a first indication of a first location of the UE relative to a second location of a point of interest (POI);
determine a distance between the first location of the UE and the second location of the POI based on the obtained first indication; and
output a second indication of whether the UE and the POI are within a proximity of one another based on the determined distance between the first location of the UE and the second location of the POI satisfying an uncertainty zone condition and based on whether a dwell time of the UE associated with the uncertainty zone condition satisfies a dwell time condition.

2. The apparatus of claim 1, wherein, to output the second indication of whether the UE and the POI are within the proximity of one another, the at least one processor is configured to:
activate a proximity trigger at the UE in response to the second indication indicating that the UE and the POI are in proximity of one another; or
activate an out of proximity trigger at the UE in response to the second indication indicating that the UE and the POI are not in proximity of one another.

3. The apparatus of claim 1, wherein, to output the second indication of whether the UE and the POI are within the proximity of one another, the at least one processor is configured to:
output the second indication of whether the UE and the POI are within the proximity of one another further based on whether a previous proximity indication of the UE indicated that the UE and the POI were within the proximity of one another.

4. The apparatus of claim 1, wherein the at least one processor is further configured to:
determine whether the determined distance between the first location of the UE and the second location of the POI satisfies the uncertainty zone condition before an output of the second indication of whether the UE and the POI are within the proximity of one another.

5. The apparatus of claim 4, wherein, to determine the distance between the first location of the UE and the second location of the POI based on the obtained first indication, the at least one processor is configured to:
determine at least one of a Euclidian distance or a Manhattan distance between the first location of the UE and the second location of the UE based on the obtained first indication, wherein, to determine whether the determined distance between the first location of the UE and the second location of the POI satisfies the uncertainty zone condition, the at least one processor is configured to:
determine whether the determined distance between the first location of the UE and the second location of the UE satisfies the uncertainty zone condition based on the determined Euclidian distance or the determined Manhattan distance.

6. The apparatus of claim 4, wherein, to determine whether the determined distance between the first location of the UE and the second location of the UE satisfies the uncertainty zone condition, the at least one processor is configured to:
assign a current distance zone to the UE based on the determined distance between the first location of the UE and the second location of the UE; and
determine that the determined distance between the first location of the UE and the second location of the UE satisfies the uncertainty zone condition in response to the assigned current distance zone satisfying the uncertainty zone condition.

7. The apparatus of claim 6, wherein, to assign the current distance zone to the UE based on the determined distance between the first location of the UE and the second location of the UE, the at least one processor is configured to:
assign a temporary distance zone to the UE based on the determined distance between the first location of the UE and the second location of the POI; and
determine the current distance zone based on whether a difference between the temporary distance zone and a previous distance zone assigned to the UE satisfies a condition distance value.

8. The apparatus of claim 7, wherein the at least one processor is further configured to:
select the condition distance value from a plurality of condition distance values based on whether the temporary distance zone is greater than the previous distance zone.

9. The apparatus of claim 1, wherein the at least one processor is further configured to:
determine whether the dwell time of the UE associated with the uncertainty zone condition satisfies the dwell time condition before an output of the second indication of whether the UE and the POI are within the proximity of one another.

10. The apparatus of claim 9, wherein the at least one processor is further configured to:
reset the dwell time of the UE associated with the uncertainty zone condition in response to a determination that the dwell time of the UE associated with the uncertainty zone condition does not satisfy the dwell time condition;
reset the dwell time of the UE associated with the uncertainty zone condition based on a second distance between a third location of the UE and a fourth location of the POI satisfying a proximity zone condition or an out of proximity zone condition; or
reset the dwell time of the UE associated with the uncertainty zone condition based on the third location of the UE or the fourth location of the POI failing to satisfy a validity condition.

11. The apparatus of claim 1, wherein the at least one processor is further configured to:
increment the dwell time of the UE associated with the uncertainty zone condition in response to a determination that the determined distance between the first location of the UE and the second location of the POI satisfies the uncertainty zone condition.

12. The apparatus of claim 11, wherein, to increment the dwell time of the UE associated with the uncertainty zone condition, the at least one processor is configured to:
increment the dwell time of the UE by a first amount in response to the determined distance between the first location of the UE and the second location of the POI satisfying a first set of zone conditions; or
increment the dwell time of the UE by a second amount in response to the determined distance between the first location of the UE and the second location of the POI satisfying a second set of zone conditions, wherein the first amount and the second amount are different, wherein the first set of zone conditions and the second set of zone conditions are non-overlapping.

13. The apparatus of claim 1, wherein the at least one processor is further configured to:
obtain a third indication of a third location of the UE relative to a fourth location of the POI; and
output a fourth indication that the UE and the POI are not within the proximity of one another based on a detection of an obstacle on a line of sight (LOS) path between the third location of the UE and the fourth location of the POI based on the obtained third indication.

14. The apparatus of claim 1, wherein the at least one processor is further configured to:
obtain a third indication of a third location of the UE relative to a fourth location of the POI;
determine a second distance between the third location of the UE and the fourth location of the POI based on the obtained third indication; and
output a fourth indication of whether the UE and the POI are within the proximity of one another based on the determined second distance between the third location of the UE and the fourth location of the POI satisfying a proximity zone condition or an out of proximity zone condition, wherein the proximity zone condition and the out of proximity zone conditions are non-overlapping.

15. The apparatus of claim 1, wherein the at least one processor is further configured to:
obtain a third indication of a third location of the UE relative to a fourth location of the POI; and
output a fourth indication of whether a second proximity of the UE and the POI are able to be determined based on whether the obtained third indication satisfies a validity condition.

16. The apparatus of claim 15, wherein the at least one processor is further configured to:
obtain a fifth indication of a fifth location of the UE relative to a sixth location of the POI after the obtainment of the third indication; and
assign a maximum distance zone to the UE based on a determination that the obtained third indication does not satisfy the validity condition.

17. The apparatus of claim 1, further comprising a transceiver coupled to the at least one processor, wherein the at least one processor is further configured to:
receive, via the transceiver, a set of positioning signals, wherein, to obtain the first indication of the first location of the UE relative to the second location of the POI, the at least one processor is configured to:
determine at least one of the first location of the UE, the second location of the POI, or the first location of the UE relative to the second location of the POI based on the received set of positioning signals.

18. The apparatus of claim 1, wherein, to output the second indication of whether the UE and the POI are within the proximity of one another, the at least one processor is configured to:
transmit the second indication of whether the UE and the POI are within the proximity of one another; or
store the second indication of whether the UE and the POI are within the proximity of one another.

19. A method of wireless communication at a user equipment (UE), comprising:
obtaining a first indication of a first location of the UE relative to a second location of a point of interest (POI);
determining a distance between the first location of the UE and the second location of the POI based on the obtained first indication; and
outputting a second indication of whether the UE and the POI are within a proximity of one another based on the determined distance between the first location of the UE and the second location of the POI satisfying an uncertainty zone condition and based on whether a dwell time of the UE associated with the uncertainty zone condition satisfies a dwell time condition.

20. A computer-readable medium storing computer executable code at a user equipment (UE), the code when executed by at least one processor causes the at least one processor to:
obtain a first indication of a first location of the UE relative to a second location of a point of interest (POI);
determine a distance between the first location of the UE and the second location of the POI based on the obtained first indication; and
output a second indication of whether the UE and the POI are within a proximity of one another based on the determined distance between the first location of the UE and the second location of the POI satisfying an uncertainty zone condition and based on whether a dwell time of the UE associated with the uncertainty zone condition satisfies a dwell time condition.
